(19) United States
(12) Patent Application Publication
(10) Pub. No.: US 2016/0016843 A1
(43) Pub. Date: Jan. 21, 2016

(54) METHOD FOR MANUFACTURING BENT OPTICAL FIBER

(71) Applicant: SUMITOMO ELECTRIC INDUSTRIES, LTD., Osaka (JP)

(72) Inventors: Yasuomi KANEUCHI, Yokohama-shi (JP); Yuuichi MITOSE, Yokohama-shi (JP)

(21) Appl. No.: 14/434,438

(22) PCT Filed: Nov. 5, 2014
(86) PCT No.: PCT/JP2014/079346

§ 371 Date: Apr. 9, 2015

(30) Foreign Application Priority Data
Nov. 25, 2013 (JP) 2013-242834

(51) Int. Cl. C03B 37/15

(52) U.S. Cl. CPC C03B 37/15; C03B 2203/06

(57) ABSTRACT

The present invention relates to a method for manufacturing a bent optical fiber while suppressing diameter reduction of the optical fiber and realizing a desired radius of curvature thereof. In an optical fiber prepared, a plurality of irradiation regions arranged along the longitudinal direction of the optical fiber are set as a heated section with infrared laser pulsed light. In each irradiation region, the optical fiber is bent at a predetermined angle in a bend processing portion softened by irradiation with the infrared laser pulsed light. The optical fiber is bent in the bend processing portions of all the irradiation regions, thereby obtaining a bent optical fiber having a predetermined radius of curvature in the heated section.

### TECHNICAL FIELD

The present invention relates to a method for manufacturing a bent optical fiber.

### BACKGROUND ART

In conjunction with high-density packaging of electron components, optical transmission media such as optical fiber used near the electronic components are also required to be packed in a lower profile.

For example, Patent Literature 1 discloses the technology of attaching a coated optical fiber to an optical component at an angle θ to a central line of the optical component. This technology allows an optical fiber component composed of the coated optical fiber and the optical component to be configured in smaller size by substantially decreasing the radius of curvature of the coated optical fiber.

Furthermore, for example, Patent Literature 2 discloses the technology of continuously heating an optical fiber while shifting an irradiation position with arc discharge along the longitudinal direction of the optical fiber, thereby bending the optical fiber. This technology allows the optical fiber to be bent in a desired radius of curvature.

### CITATION LIST

### Patent Literatures

Patent Literature 1: Japanese Patent Application Laid-open Publication No. 2004-325622
Patent Literature 2: International Publication WO 2010/044273

### SUMMARY OF INVENTION

### Technical Problem

The Inventors conducted research on the conventional bend processing technologies for optical fiber and found the problem as described below. Specifically, the technology described in the foregoing Patent Literature 1 is to give the angle θ to the coated optical fiber at one point in an end portion of the optical component. For this reason, stress is concentrated in a bent portion of the coated optical fiber, so as to easily cause the problem of diameter reduction of the coated optical fiber. The technology described in the foregoing Patent Literature 2 is to continuously heat the optical fiber along its longitudinal direction, thereby implementing the bend processing for the optical fiber. For this reason, the optical fiber is heated more than necessary, so as to easily cause the problem of diameter reduction of the optical fiber.

The present invention has been accomplished in order to solve the problem as described above, and it is an object of the present invention to provide a method for manufacturing a bent optical fiber while suppressing the diameter reduction of the optical fiber and realizing a desired radius of curvature.

### Solution to Problem

An embodiment of the invention relates to a method for manufacturing a bent optical fiber obtained by repeating local bend processing by irradiation with infrared laser pulsed light, for an optical fiber comprised of silica glass and having a first end face and a second end face opposed to the first end face. Specifically, a method for manufacturing a bent optical fiber according to a first aspect of the embodiment of the invention comprises: preparing an optical fiber comprised of silica glass and having a first end face and a second end face opposed to the first end face; and preparing a heat source for outputting laser light (e.g., infrared laser pulsed light) having a thermal power distribution with a maximum thermal power on an optical axis of the optical fiber. Processes of bending the optical fiber and moving an irradiation position are repeated in a heated section set between the first end face and the second end face of the optical fiber, whereby the optical fiber is bent in a predetermined radius of curvature in the heated section of the optical fiber. In the process of bending the optical fiber, an irradiation region of the optical fiber is irradiated with the laser light and, in an irradiation period with the laser, the optical fiber is bent in a bend processing portion softened by irradiation with the laser in the irradiation region. A width of the bend processing portion along the longitudinal direction of the optical fiber is narrower than a width of the irradiation region. In the process of moving the irradiation position, which is executed after the process of bending the optical fiber, the irradiation position with the laser light is moved by a predetermined moving amount along the longitudinal direction of the optical fiber. The predetermined moving amount is such an amount that, in next laser irradiation to form a next irradiation region and a next bend processing portion included in the next irradiation region in the optical fiber, the irradiation region in the process of bending the optical fiber overlaps in part with the next irradiation region and the bend processing portion in the process of bending the optical fiber is separated from the next bend processing portion.

A method for manufacturing a bent optical fiber according to a second aspect of the embodiment of the invention is also applicable to the foregoing first aspect and comprises at least a first bending step and a second bending step. In the first bending step, while a first irradiation region of an optical fiber is heated by irradiation with infrared laser pulsed light, the optical fiber is bent at a first angle (bend angle) in a first bend processing portion softened by irradiation with the infrared laser pulsed light in the first irradiation region (first part). In the second bending step, while a second irradiation region (second part) of the optical fiber different from the first irradiation region is heated by irradiation with the infrared laser pulsed light, the optical fiber is bent at a second angle (bend angle) in a second bend processing portion softened by irradiation with the infrared laser pulsed light in the second irradiation region. A heated section of the optical fiber irradiated with the infrared laser pulsed light is configured of a plurality of irradiation regions including the first irradiation region and the second irradiation region and this configuration can be realized by carrying out the second bending step at least once. When the optical fiber prepared is subjected to n (natural number of not less than 2) bending steps, the bending step carried out for the first time corresponds to the first bending step. The bending step carried out for the nth time corresponds to the second bending step and the irradiation region in the (n−1)th bending step corresponds to the first irradiation region. The optical fiber is bent in each of a plurality of irradiation regions in this manner, thereby obtaining the bent optical fiber having the predetermined radius of curvature in the heated section.

As a third aspect applicable to at least either one of the first and second aspects, the first bend processing portion and the second bend processing portion are preferably separated along the longitudinal direction of the optical fiber. As a fourth aspect applicable to at least any one of the first to third aspects, the first bending step is to bend the optical fiber so that a first angle is made between central axes of non-softened portions each adjacent to the first bend processing portion. In the second bending step, the second irradiation region is formed at a position shifted along the longitudinal direction of the optical fiber with respect to the forming position of the first irradiation region, and the optical fiber is bent so that a second angle is made between central axes of non-softened portions each adjacent to the second bend processing portion. The heated section is defined by a section extending along the longitudinal direction of the optical fiber, as ranging from the irradiation region closest to the first end face to the irradiation region closest to the second end face out of the plurality of irradiation regions.

As a fifth aspect applicable to at least any one of the first to fourth aspects, each of the first bending step and the second bending step is preferably carried out in a state in which a load member is attached to the first end face side of the optical fiber with respect to the first irradiation region and the second irradiation region and in which the second end face side of the optical fiber with respect to the first irradiation region and the second irradiation region is fixed.

As a sixth aspect applicable to at least any one of the first to fifth aspects, the infrared laser pulsed light preferably includes laser light with a wavelength over 1.5 μm.

As a seventh aspect applicable to at least any one of the first to sixth aspects, the infrared laser pulsed light to irradiate the first irradiation region preferably has a power distribution in which thermal power in the first bend processing portion is higher than thermal power in the rest portion except for the first bend processing portion. The infrared laser pulsed light to irradiate the second irradiation region also preferably has a power distribution in which thermal power in the second bend processing portion is higher than thermal power in the rest portion except for the second bend processing portion.

As an eighth aspect applicable to at least any one of the first to seventh aspects, the heated section of the optical fiber may be bent in the predetermined radius of curvature by controlling a pulse count of the infrared laser pulsed light to irradiate one irradiation region and a center distance of each of the plurality of irradiation regions, as an irradiation condition with the infrared laser pulsed light to irradiate each of the plurality of irradiation regions. As a ninth aspect applicable to at least any one of the first to eighth aspects, the heated section of the optical fiber may be bent in the predetermined radius of curvature by setting the number of the plurality of irradiation regions irradiated with the infrared laser pulsed light.

As a tenth aspect applicable to at least any one of the first to ninth aspects, the optical fiber may be a multi-core optical fiber having a plurality of cores extending along a predetermined axis. In this case, the multi-core optical fiber is preferably bent so that there is no neighboring core out of the plurality of cores on a bend axis which is defined by a straight line perpendicular to the predetermined axis and which coincides with a bend direction in each of the first bend processing portion and the second bend processing portion.

### Advantageous Effect of Invention

According to the embodiment of the invention, the bent optical fiber is obtained while effectively suppressing the diameter reduction of the optical fiber and being bent in the desired radius of curvature.

### BRIEF DESCRIPTION OF DRAWINGS

FIG. 1 is a drawing for explaining a preparing step in a method for manufacturing a bent optical fiber according to the embodiment of the invention.

FIG. 2 is a drawing for explaining a load member attaching step in the method for manufacturing the bent optical fiber according to the embodiment of the invention.

FIGS. 3A and 3B are drawings for explaining a first bending step in the method for manufacturing the bent optical fiber according to the embodiment of the invention.

FIGS. 4A and 4B are drawings for explaining a second bending step in the method for manufacturing the bent optical fiber according to the embodiment of the invention.

FIG. 5 is a drawing for explaining an entire structure of the bent optical fiber obtained by the method for manufacturing the bent optical fiber according to the embodiment of the invention.

FIGS. 6A to 6C are drawings for explaining an angle in a bend processing portion, bend angles in a heated section, and the radius of curvature in the heated section.

FIG. 7 is a cross-sectional view of a multi-core optical fiber.

FIG. 8 is a graph showing a thermal energy distribution of infrared laser pulsed light against position of optical fiber in the method for manufacturing the bent optical fiber according to the embodiment of the invention.

FIG. 9 is a graph showing a thermal energy distribution of arc discharge against position of optical fiber in the conventional manufacturing method of bent optical fiber.

FIG. 10 is a graph showing a bent state of the optical fiber against position by the method for manufacturing the bent optical fiber according to the embodiment of the invention.

FIG. 11 is a graph showing a bent state of the optical fiber against position by the conventional manufacturing method of bent optical fiber.

FIG. 12 is a photograph showing an example of appearance of the bent optical fiber according to the embodiment of the invention.

FIG. 13 is a table showing the measurement results of bend angles and radii of curvature, for a plurality of samples of bent optical fibers according to the embodiment of the invention.

### DESCRIPTION OF EMBODIMENTS

Each of embodiments of the present invention will be described below in detail with reference to the accompanying drawings. In the description of the drawings the same elements will be denoted by the same reference signs, without redundant description.

A method for manufacturing a bent optical fiber according to an embodiment of the invention has a preparing step, an attaching step, a first bending step, and a second bending step. It is noted that the second bending step may be carried out multiple times and that the nth bending step (n is a natural number of not less than 2) disclosed below shall include the second bending step.

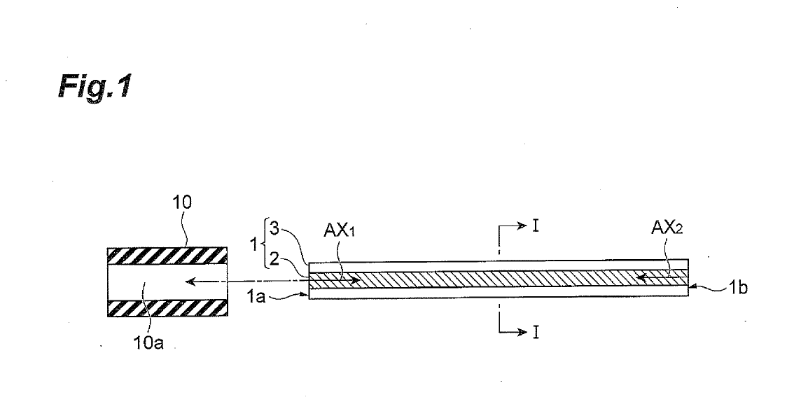

FIG. 1 is a drawing for explaining the preparing step in the method for manufacturing the bent optical fiber according to the embodiment of the invention. The preparing step is to prepare an optical fiber 1 and a load member 10 (weight). This FIG. 1 shows a cross section along the fiber axis direction.

The optical fiber 1 is a single-core optical fiber, in which a core extending along the fiber axis direction is surrounded by a cladding 3. The refractive index of the core 2 is higher than that of the cladding 3. The cross-sectional shape of the core 2 perpendicular to the fiber axis is circular. Each of the core 2 and the cladding 3 consists primarily of silica glass and is doped with an impurity for adjustment of refractive index as needed. For example, the core 2 is silica glass doped with GeO₂ and the cladding 3 is pure silica glass. As another example, the core 2 may be pure silica glass and the cladding 3 may be silica glass doped with Element F. The optical fiber 1 before bend processing shown in FIG. 1 has a first end face 1a and a second end face 1b opposed to the first end face 1a, and a central axis AX₁ of one end including the first end face 1a and a central axis AX₂ of the other end including the second end face 1b are present as the fiber axis on the same straight line.

The load member 10 is a cylindrical body having a through hole 10a with the diameter equal to the outer diameter of the optical fiber 1. The load member 10 may be a cylindrical body such as a ferrule for connector. The load member 10 can be made of any material that remains unmelted with laser irradiation. The load member 10 may have the shape other than the cylindrical body but is preferably the cylindrical body in terms of preventing unintended deformation such as twisting during processing. Furthermore, the load member 10 may be a part of a completed product including the optical fiber 1 after the bend processing (bent optical fiber). The load member 10 may be once removed from the optical fiber 1, after the bend processing. In this case, a component to become a part of the completed product may be mounted as a part of the completed product on the end including the first end face 1a of the optical fiber 1 after the bend processing.

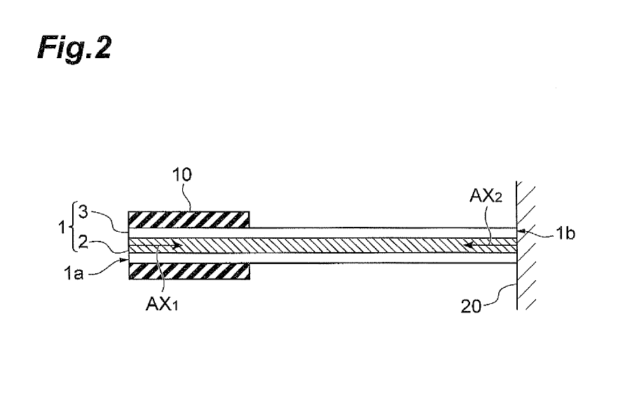

FIG. 2 is a drawing for explaining the attaching step in the method for manufacturing the bent optical fiber according to the embodiment of the invention. In the attaching step, the one end side including the first end face 1a of the optical fiber 1 is inserted into the through hole 10a of the load member 10. In this inserted state, the outer peripheral surface of the one end of the optical fiber 1 including the first end face 1a is joined to the inner peripheral surface of the through hole 10a of the load member 10, whereby the load member 10 is mounted on the one end side of the optical fiber 1 including the first end face 1a. Furthermore, the other end side of the optical fiber 1 including the second end face 1b is fixed to a fixing portion 20. By this, the load member 10 and the optical fiber 1 become held in a cantilever state.

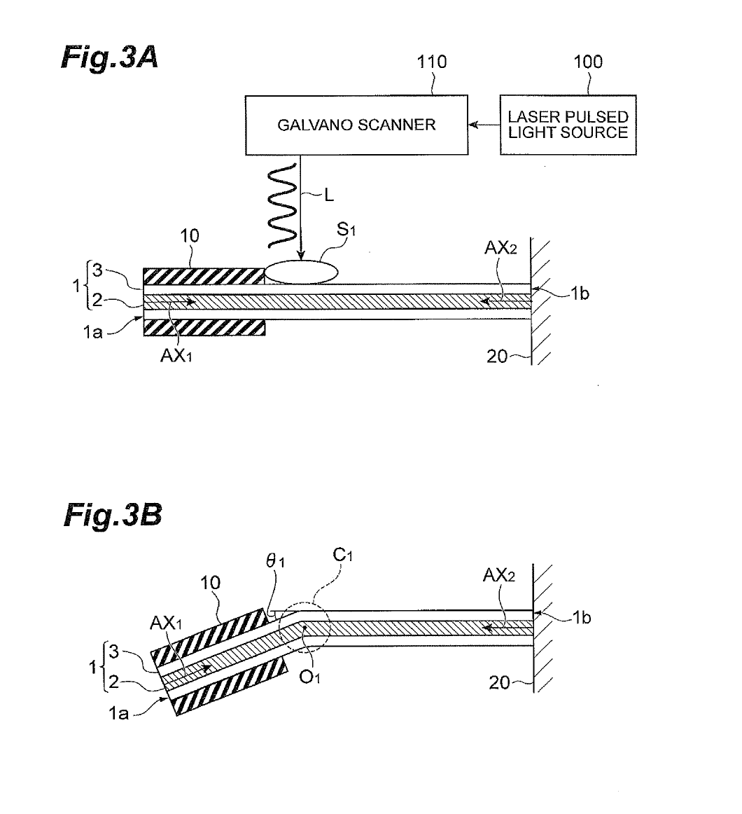

FIGS. 3A and 3B are drawings for explaining the first bending step in the method for manufacturing the bent optical fiber according to the embodiment of the invention. In the first bending step, first, a first irradiation region (first part) S₁ of the optical fiber 1 not covered by the load member 10 is irradiated with infrared laser pulsed light L from a heat source 100 through a galvano scanner 110, as shown in FIG. 3A. The first irradiation region S₁ is heated by this irradiation with the infrared laser pulsed light L and a part (first bend processing portion C₁) of the first irradiation region S₁ becomes soft. It is sufficient that the first irradiation region S₁ being an irradiation region be one having the length along the fiber axis direction not less than the fiber diameter. This means that, since the infrared laser pulsed light L is usually a circular spot beam, the optical fiber 1 needs to be entirely covered in radial directions by the irradiation region, when viewed from the irradiation direction of the infrared laser pulsed light L. Namely, the spot diameter (width in the longitudinal direction of the optical fiber 1) of the infrared laser pulsed light (laser light) is preferably equal to the diameter of the optical fiber 1 or not less than at least twice the diameter. The load of the load member 10, together with the weight of the optical fiber 1 itself, is imposed on the first bend processing portion C₁ softened by the irradiation with the infrared laser pulsed light L in this manner. For this reason, as shown in FIG. 3B, the optical fiber 1 is bent at a first angle θ₁ (bend angle) around the first bend processing portion C₁ included in the first irradiation region S₁ and, specifically, around a center at its central point θ₁ (position where the thermal power of the infrared laser pulsed light becomes maximum in the softened first bend processing portion C₁).

Here, the heat source 100 for the optical fiber 1 shown in FIG. 3A may be any laser light source that outputs light including laser light with the wavelength over 1.5 μm, or laser light in the wavelength band from infrared to near infrared capable of thermal processing, and it is preferably a CO₂ laser light source. In the example of FIGS. 3A and 3B, the laser pulsed light source is shown as the heat source 100. With use of the laser light, the optical fiber 1 can be bent in close proximity to the load member 10. Since the bending step does not cause the load member 10 to adhere to the optical fiber 1, it is also possible to remove the load member 10. When the infrared laser light from the heat source 100 is pulsed, thermal influence per pulse is less likely to remain on the optical fiber 1.

It is necessary to avoid melting or excessive softening of the optical fiber 1 itself due to excessive heating. The former causes the diameter reduction of the optical fiber 1 to result in reduction of mechanical strength. The latter causes the optical fiber 1 to be bent at 9.0° by only one bend, resulting in an optical loss. Therefore, it is necessary to preliminarily examine and capture relationships among irradiation time per region of irradiated part, repetitive frequency, pulse width, pulse energy, and pulse peak power, and to appropriately select a preferred one.

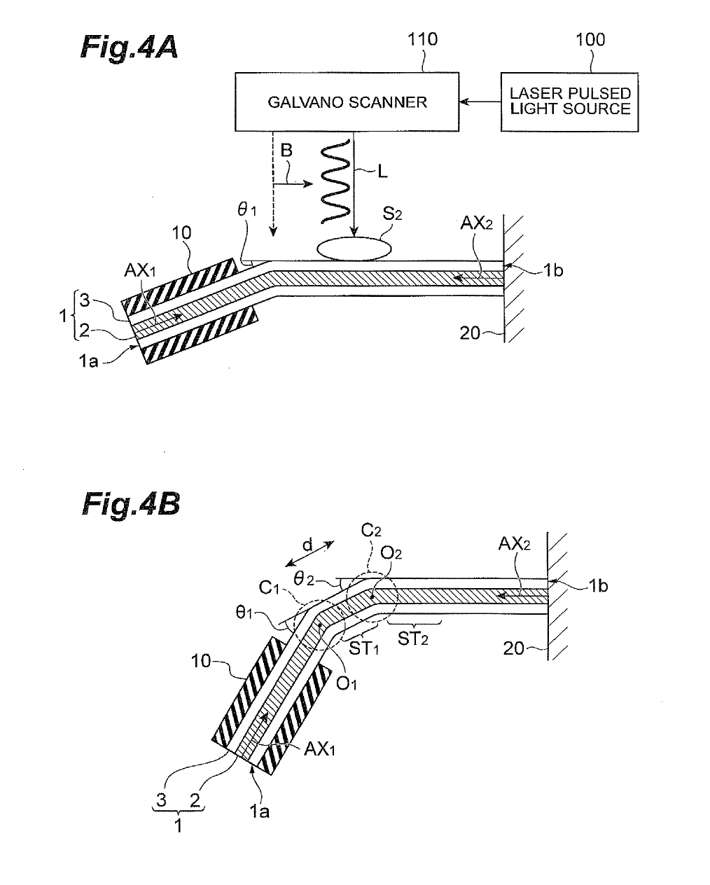

FIGS. 4A and 4B are drawings for explaining the second bending step in the method for manufacturing the bent optical fiber according to the embodiment of the invention. In the second bending step, as shown in FIG. 4A, a section not covered by the load member 10, which is a second irradiation region (second part) S₂ of the optical fiber 1 different from the first irradiation region S₁, is irradiated with the infrared laser pulsed light from the heat source 100 through the galvano scanner 110. Specifically, the galvano scanner 110 shifts the propagation path of the infrared laser pulsed light in a direction indicated by arrow B, whereby the second irradiation region S₂ comes to be located with a shift along the longitudinal direction of the optical fiber 1 from the first irradiation region S₁. The second irradiation region S₂ is heated by this laser irradiation and a part (second bend processing portion C₂) of the second irradiation region S₂ becomes soft. The second irradiation region S₂ being an irradiation region is the irradiation region different from the first irradiation region S₁ and, as shown in FIG. 4A, it is the irradiation region with a shift of a certain distance from the first irradiation region S₁ in the direction from the first end face 1a toward the second end face 1b of the optical fiber 1. The load of the load member 10, together with the weight of the optical fiber 1 itself, is imposed on the second bend processing portion C₂ softened by the irradiation with the infrared laser pulsed light L in this manner. For this reason, as shown in FIG. 4B, the optical fiber 1 is bent at a second angle θ₂ (bend angle) around the second bend processing portion C₂ included in the second irradiation region S₂ and, specifically, around a center of its central point θ₂ (position where the thermal power of the infrared laser pulsed light becomes maximum in the softened second bend processing portion C₂).

The irradiation with the infrared laser pulsed light L is carried out while shifting the irradiation position with the infrared laser pulsed light L at prescribed intervals in the direction from the first end face 1a toward the second end face 1b of the optical fiber 1 in this manner, whereby the optical fiber 1 is bent in a heated section (including a plurality of irradiation regions each irradiated with the infrared laser pulsed light). A moving amount of the irradiation position can be not more than the length of each irradiation region in the fiber axis direction. The moving amount of the irradiation position is an interval between center positions of irradiation regions. Namely, in the example of FIG. 4B, the moving amount of the irradiation position is equal to a center distance d between the first irradiation region S₁ and the second irradiation region S₂ being the irradiation regions and, more specifically, it is equal to a center distance d between the center point O₁ of the first bend processing portion C₁ included in the first irradiation region S₁ and the center point θ₂ of the second bend processing portion C₂ included in the second irradiation region S₂. Therefore, there is a non-softened portion ST₁ between the first bend processing portion C₁ and the second bend processing portion C₂. Explaining the example of FIG. 4B, there are the non-softened portion ST₁ on the first end face 1a side of the second bend processing portion C₂ (hereinafter referred to as first-end-face-side non-softened portion) and a second-end-face-side non-softened portion ST₂ on the second end face 1b side of the second bend processing portion C₂.

The movement of the irradiation position may be implemented by use of the galvano scanner 110, as shown in FIG. 3A and FIG. 4A, so as to change the optical path of the infrared laser pulsed light, or by use of a moving stage so as to move the position of the heat source 100 relative to the optical fiber 1. Furthermore, a rotary stage with a lever may be used so as to bend the optical fiber with the lever in conjunction with the movement of the irradiated part. An example of the rotary stage is the one described in Patent Literature 2.

The optical fiber at a stage after completion of both the first bending step and the second bending step is bent in the heated section of the optical fiber 1, including the first irradiation region S₁ and the second irradiation region S₂, and the bend angle θ thereof is the sum of the first angle θ₁ and the second angle θ₂. In the bending steps of the present embodiment, the optical fiber 1 is bent so as to locate each of the central axis AX₁ of one end including the first end face 1a, the central axis of the first-end-face-side non-softened portion ST₁, the central axis of the second-end-face-side non-softened portion ST₂, and the central axis. AX₂ of the other end including the second end face 1b, on the same plane before and after the bend processing.

In the nth bending step (n is a natural number of not less than 2) including the second bending step, after the first bending step, the nth irradiation region Sₙ of the optical fiber 1 not covered by the load member 10 is irradiated with the infrared laser pulsed light L. On that occasion, a part (nth bend processing portion Cₙ) of the nth irradiation region Sₙ is softened by irradiation with the infrared laser pulsed light L. The nth irradiation region Sₙ being an irradiation region is the irradiation region with a shift of the fixed center distance d from the (n−1)th irradiation region Sₙ₋₁ in the direction from the first end face 1a toward the second end face 1b of the optical fiber 1. The load of the load member 10, together with the weight of the optical fiber 1 itself, is imposed on the nth bend processing portion Cₙ softened by the irradiation with the infrared laser pulsed light L. For this reason, the optical fiber 1 is bent at the nth angle θᵣ, (bend angle) around the nth bend processing portion Cₙ and, specifically, around a center at its central point Oₙ.

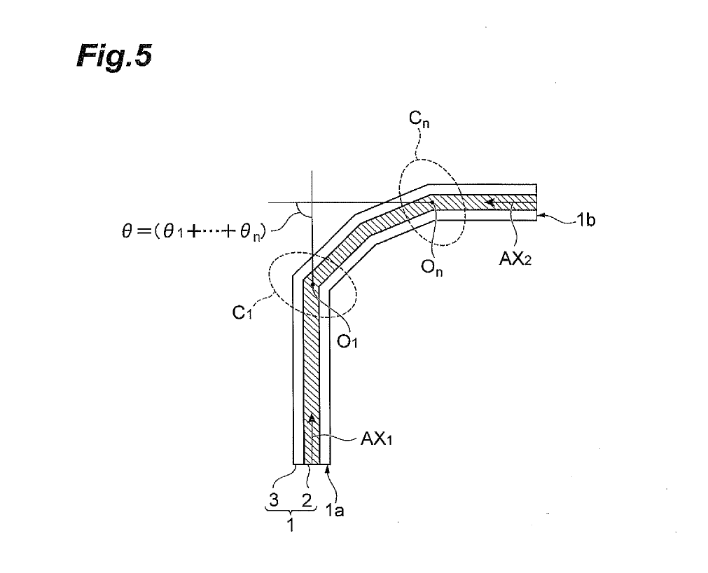

By the method for manufacturing the bent optical fiber according to the embodiment of the invention as described above, the optical fiber 1 can be bent in the heated section including the irradiation regions S₁ to Sₙ, so as to be processed at a desired bend angle θ in a desired radius of curvature. The final bend angle θ in the heated section is the sum of the first angle θ₁, the second angle θ₂, . . . , and the nth angle θₙ. Namely, FIG. 5 shows the optical fiber 1 after the bend processing to perform the first bending step and the nth bending step (including the second bending step) subsequent thereto as described above. In the example of FIG. 5, the load member 10 has been removed from the end of the optical fiber 1 including the first end face 1a.

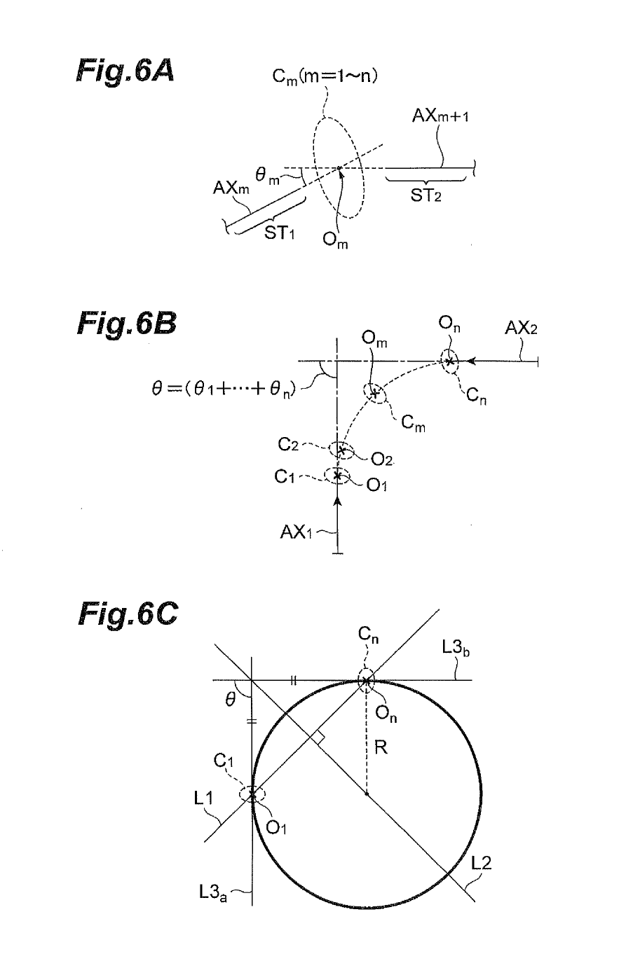

The bend angle θ in the mth bend processing portion Cₘ (m=1 to n) out of the first to nth bend processing portions C₁ to Cₙ means an angle made between the respective central axes AXₘ, AXₘ₊₁ of the first-end-face-side non-softened portion ST₁ and the second-end-face-side non-softened portion ST₂ adjacent to the mth bend processing portion Cₘ, as shown in FIG. 6A.

The bend angle θ in the heated section including a plurality of irradiation regions S₁ to Sₙ is represented by a total of the bend angles θ₁ to θ₁ in the first to nth bend processing portions C₁ to Cₙ, as shown in FIG. 6B, and the bend angle θ in the heated section corresponds to an angle made between the central axis AX₁ of the end including the first end face 1a and the central axis AX₂ of the end including the second end face 1b. The optical fiber 1 is bent so that the central axis AX₁ of the end including the first end face 1a, the first to nth bend processing portions C₁ to Cₙ, and the central axis AX₂ of the end including the second end face 1b are located on the same plane before and after each of the bending steps.

The radius of curvature in the heated section of the optical fiber 1 subjected to the first to nth bending steps is defined as shown in FIG. 6C. Specifically, a perpendicular bisector L2 is drawn to a line segment (straight line L1 in FIG. 6C) connecting the central point θ₁ of the first bend processing portion C₁ closest to the first end face 1a and the central point Oₙ of the nth bend processing portion Cₙ closest to the second end face 1b, out of the plurality of irradiation regions S₁ to Sₙ included in the heated section (specifically, the first to nth bend processing portions C₁ to Cₙ), and two straight lines L3a, L3b are specified as straight lines passing the respective central points O₁, Oₙ and intersecting at the angle θ on the perpendicular bisector L2. Then, the radius of a circle tangent lines to which at the respective central points O₁, Oₙ are the two straight lines L3a, L3b is defined as the radius of curvature in the heated section of the optical fiber 1 obtained through all the bending steps.

In the present embodiment, the load member 10 is mounted on the end including the first end face 1a of the optical fiber 1, but the position where the load member 10 is mounted may be anywhere on the first end face 1a side of the optical fiber 1 with respect to the first irradiation region S₁. Each of the second irradiation region S₂ and subsequent irradiation regions is located away from the first irradiation region S₁ in the direction from the first end face 1a toward the second end face 1b of the optical fiber 1. For this reason, the load member 10 is located on the first end face 1a side of the optical fiber 1 with respect to each of the irradiation regions S₁ to Sₙ including the first irradiation region S₁ and the second irradiation region S₂.

In the present embodiment, the second end face 1b of the optical fiber 1 was fixed to the fixing portion 20, but the fixing position to the fixing portion 20 may be anywhere on the second end face 1b side of the optical fiber 1 with respect to each of the irradiation regions S₁ to Sₙ including the first irradiation region S₁ and the second irradiation region S₂.

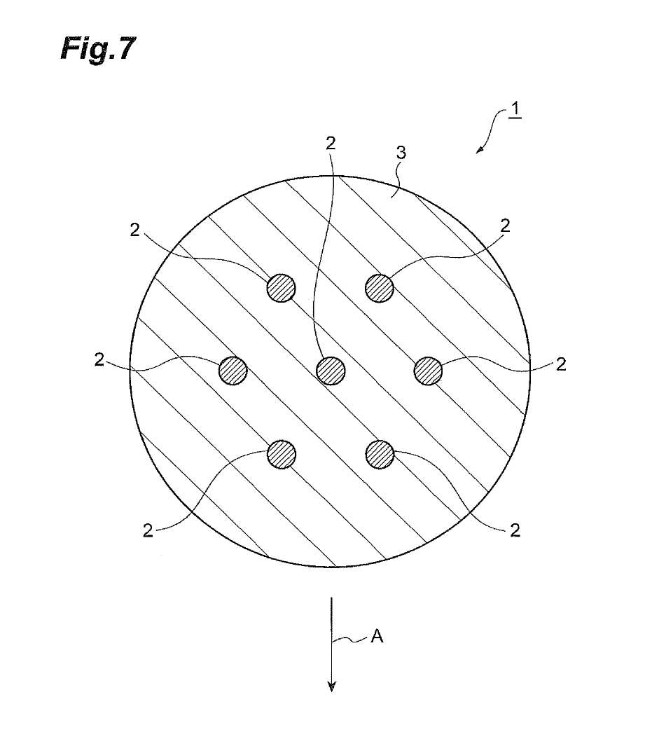

The optical fiber 1 used in the present embodiment was described as a single-core optical fiber, but does not have to be limited to this. The optical fiber 1 applicable herein can also be a multi-core optical fiber having a plurality of cores each extending along a predetermined axis. FIG. 7 is a cross-sectional view of a multi-core optical fiber and shows a cross section of the multi-core optical fiber corresponding to the cross section of the optical fiber 1 along the line I-I in FIG. 1. The optical fiber 1 has seven cores 2 extending along the fiber axis direction and surrounded by a common cladding 3. In the cross section, one core out of the seven cores 2 is arranged in the center and the other six cores are arranged at equal intervals on the circumference of a circle centered on the center core.

In the case of the multi-core optical fiber, if there is an adjacent core on a bend axis coincident with a bend direction A, crosstalk can be caused between adjacent cores. Therefore, the bend direction A (coincident with the bend direction in each of the first to nth bend processing portions in FIG. 6B) is preferably set so that there is no adjacent core on the bend axis coincident with the bend direction A. It should be noted that the multi-core optical fiber shown in FIG. 7 is just an example and that the arrangement of cores does not have to be limited to this.

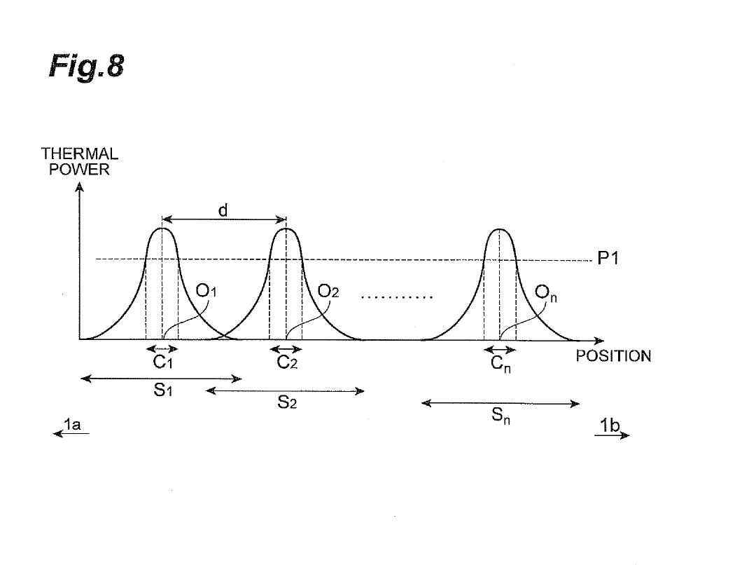

FIG. 8 is a graph showing a thermal energy distribution of the infrared laser pulsed light L against position of the optical fiber in the method for manufacturing the bent optical fiber according to the embodiment of the invention. The horizontal axis represents the position in the fiber axis direction of the optical fiber 1. In FIG. 8 the left side is the first end face 1a side of the optical fiber 1 and the right side the second end face 1b side. The first irradiation region S₁, the second irradiation region S₂, . . . , and the nth irradiation region Sₙ are arranged at intervals of the center distance d in order from the first end face 1a side of the optical fiber 1. Since the center distance d is smaller than each of the irradiation regions S₁ to Sₙ being the irradiation regions herein, the irradiation regions S₁ to Sₙ overlap with each other.

The infrared laser pulsed light L has a power distribution with a maximum power at its center. Regions where the thermal power exceeds a predetermined power P1 contribute to bending of the optical fiber 1. The region where the thermal power exceeds the predetermined power P1 in the first irradiation region S₁ is the first bend processing portion C₁ and the position O₁ of the maximum power corresponds to the centers of both the first irradiation region S₁ and the first bend processing portion C₁. Namely, the thermal power in the first bend processing portion C₁ is higher than that in the rest region in the first irradiation region S₁ being the irradiation region with the infrared laser pulsed light L.

Furthermore, the region where the thermal power exceeds the predetermined power P1 in the second irradiation region S₂ is the second bend processing portion C₂ and the position O₂ of the maximum power corresponds to the centers of both the second irradiation region S₂ and the second bend processing portion C₂. Namely, the thermal power in the second bend processing portion C₂ is higher than that in the rest region in the second irradiation region S₂ being the irradiation region with the infrared laser pulsed light L. Similarly, the region where the thermal power exceeds the predetermined power P1 in the nth irradiation region Sₙ is the nth bend processing portion Cₙ. Namely, the thermal power in the nth bend processing portion Cₙ is higher than that in the rest region in the nth irradiation region Sₙ being the irradiation region with the infrared laser pulsed light L.

The irradiation regions S₁ to Sₙ overlap with each other, whereas the bend processing portions C₁ to Cₙ do not overlap with each other (or there are non-softened portions between the bend processing portions C₁ to Cₙ) because the power distribution of the infrared laser pulsed light L is set so as to separate the bend processing portions C₁ to Cₙ from each other. Since the infrared laser pulsed light L is light with the high peak power but short pulse width, glass is less likely to damage. Furthermore, influence on glass can be minimized by adjusting the pulse width, peak power value, pulse count, and irradiation region (or, alternatively, degree of concentration) of the infrared laser pulsed light L.

The bend processing portions C₁ to Cₙ are preferably not less than the size equal to the fiber diameter. However, if the size is too large, a modified region will increase so as to raise a possibility of causing some adverse effect and thus the bend processing portions C₁ to Cₙ preferably have such size as to prevent excessive increase of the modified region.

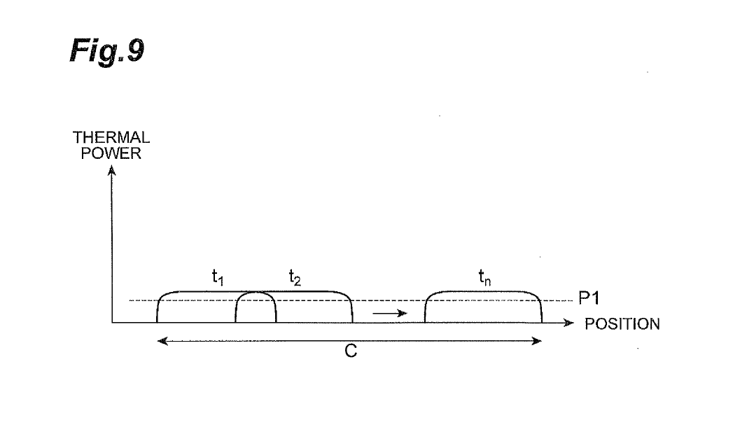

FIG. 9 is a graph showing a thermal energy distribution of arc discharge against position of optical fiber in the conventional manufacturing method of bent optical fiber (Patent Literature 2). The optical fiber is bent by continuously moving a heated region with arc discharge in the fiber axis direction between a processing start time t₁ and a processing end time tₙ. A bend processing portion C is one continuous region and continuous bending is effected throughout the entire irradiation region with arc discharge. The thermal power is illustrated as being flat herein for simplicity, but the thermal power is considered to vary in fact.

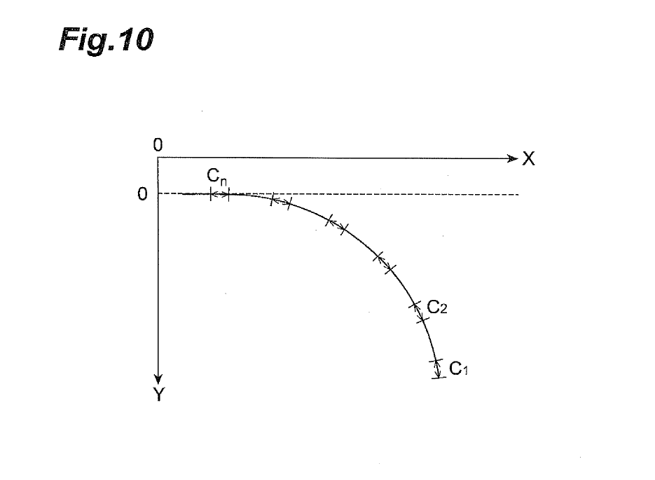

FIG. 10 is a graph showing a bent state against position of the optical fiber by the method for manufacturing the bent optical fiber according to the embodiment of the invention. The X-axis represents the distance in the fiber axis direction (in an unbent state) from the second end face 1b of the optical fiber 1. The Y-axis represents moving distance of movement of each portion of the optical fiber 1 in the bend direction, with respect to the position of the second end face 1b of the optical fiber 1. The bend processing portions C₁ to Cₙ are arranged as separated as shown.

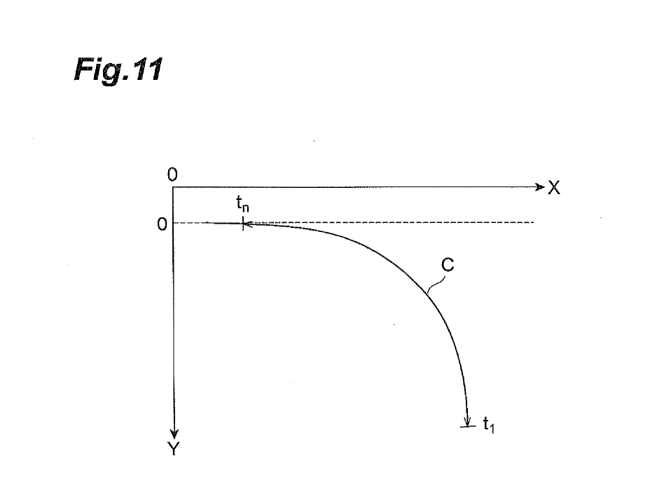

FIG. 11 is a graph showing a bent state against position of the optical fiber by the conventional manufacturing method of bent optical fiber. The continuous region in the period from the time t₁ to tₙ is the irradiation region and bend processing portion C.

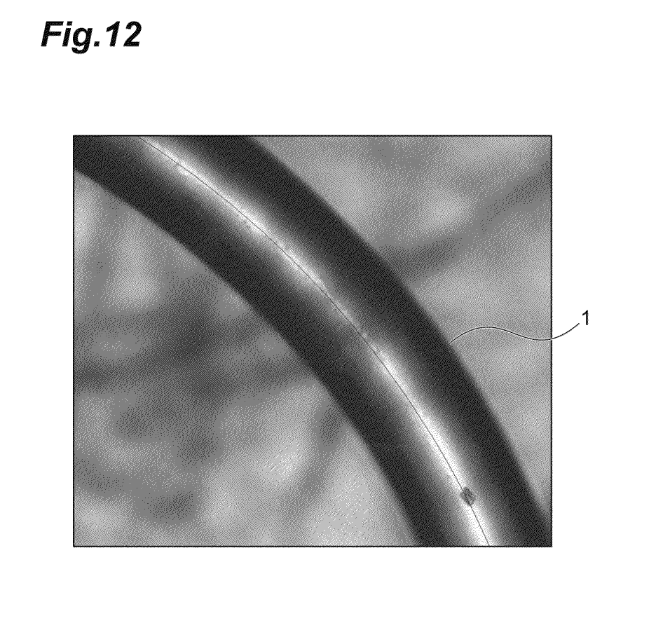

FIG. 12 is a photograph showing an example of appearance (part of the heated section) of the bent optical fiber according to the embodiment of the invention. As seen from FIG. 12, there is no diameter reduction observed in the optical fiber 1 (bent optical fiber) after completion of all the bending steps.

As described above, since the method for manufacturing the bent optical fiber according to the embodiment of the invention is configured to heat the optical fiber 1 with the infrared laser pulsed light L, the heated state of the optical fiber 1 can be controlled easier by controlling the number of pulses of the infrared laser pulsed light to be irradiated, than in the case of continuous heating. Therefore, this method is unlikely to induce the melting or excessive softening of the optical fiber 1 due to excessive heating, thus solving the problems of diameter reduction of the optical fiber 1 and 90° bend by only bending at one location.

Furthermore, the optical fiber 1 is bent by each of the predetermined angles θ₁ to θₙ in the respective irradiation regions S₁ to Sₙ separated in the longitudinal direction of the optical fiber 1, whereby the optical fiber 1 is bent in the predetermined radius of curvature in the entire heated section including these irradiation regions S₁ to Sₙ (cf. FIG. 5 and FIG. 6B). Therefore, when compared to the case where the optical fiber is bent by only bending at one location, bending stress can be dispersed over the irradiation regions S₁ to Sₙ and thus the problem of diameter reduction of the optical fiber 1 is less likely to arise. By controlling the center distance of each of the irradiation regions S₁ to Sₙ, the optical fiber 1 can be readily bent in the desired radius of curvature.

In the embodiment of the invention, the load member 10 is mounted on the fiber end including the first end face 1a of the optical fiber 1, while the fiber end including the second end face 1b is fixed to the fixing portion 20. For this reason, the optical fiber 1 softened with the infrared laser pulsed light L can be readily bent by the load of the load member 10 and the weight of the optical fiber 1 itself.

The below will describe a plurality of samples of bent optical fibers obtained by the method for manufacturing the bent optical fiber according to the embodiment of the invention. First, the optical fibers and load members were prepared. The optical fibers prepared were single-core optical fibers with the outer diameter of 0.125 mm. The load members prepared are capillaries made of borosilicate glass and having the outer diameter of 1.8 mm, the length of 6.05 mm, and the weight of 0.04 g.

Using a CO₂ laser light source as an irradiating device, the prepared optical fibers were irradiated with laser pulsed light (adjusted at the repetitive frequency 20 kHz, the average power 10.4 W, and the diameter 3 mm of an irradiated mark on an acrylic plate as the irradiation region with the laser pulsed light) for one second at one location. Use of the laser pulsed light enabled discrete and intermittent irradiation steps and use of local and temporary heating suppressed heating of unwanted portion of optical fiber more than necessary.

The movement of the irradiation position was implemented by use of the galvano scanner. The bending of optical fiber was implemented by the load of the load member (weight) and the weight of the optical fiber itself.

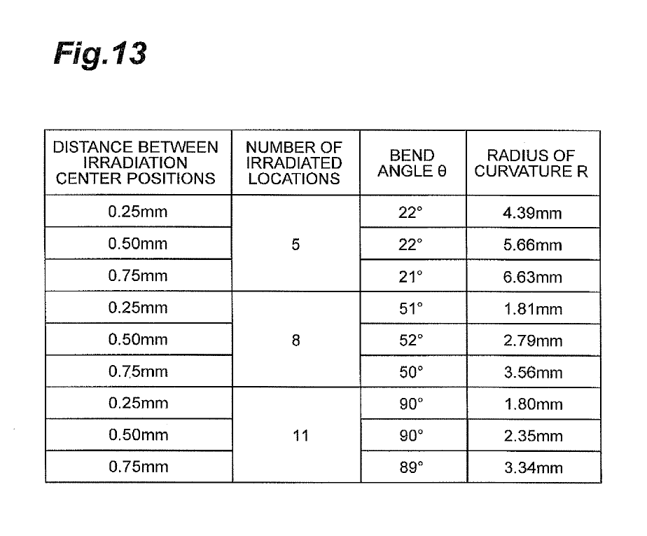

FIG. 13 shows the results of measurement of bend angles and radii of curvature, for the bent optical fibers manufactured with variation of the distance between the center positions of the irradiation regions and the number of irradiated portions. It was confirmed that the bend angle varied depending upon the number of irradiated portions and that the radius of curvature varied depending upon the distance between the irradiation center positions.

### REFERENCE SIGNS LIST

1 optical fiber; 1a one end; 1b other end; 10 load member (weight); d center distance; A bend direction; C1 first bend processing portion; C2 second bend processing portion; L infrared laser pulsed light; S1 first irradiation region (first part); S2 second irradiation region (second part); θ₁ first angle; θ₂ second angle.

1. A method for manufacturing a bent optical fiber obtained by performing bend processing for an optical fiber comprised of silica glass and having a first end face and a second end face opposed to the first end face, the method comprising:
a first bending step of irradiating a first irradiation region of the optical fiber with infrared laser pulsed light in order to partially soften the optical fiber, and, in an irradiation period with the infrared laser pulsed light, bending the optical fiber at a first angle in a first bend processing portion softened by irradiation with the infrared laser pulsed light in the first irradiation region; and
a second bending step of irradiating a second irradiation region of the optical fiber different from the first irradiation region with the infrared laser pulsed light in order to partially soften the optical fiber in a portion different from the first bend processing portion, and, in an irradiation period with the infrared laser pulsed light, bending the optical fiber at a second angle in a second bend processing portion softened by irradiation with the infrared laser pulsed light in the second irradiation region,
wherein in a heated section of the optical fiber irradiated with the infrared laser pulsed light and comprised of a plurality of irradiation regions including the first irradiation region and the second irradiation region, the optical fiber is bent in a predetermined radius of curvature.

2. The method for manufacturing a bent optical fiber according to claim 1, wherein the first bend processing portion and the second bend processing portion are separated along a longitudinal direction of the optical fiber.

3. The method for manufacturing a bent optical fiber according to claim 1, wherein each of the first bending step and the second bending step is carried out in a state in which a load member is attached to the first end face side of the optical fiber with respect to the first irradiation region and the second irradiation region and in which the second end face side of the optical fiber with respect to the first irradiation region and the second irradiation region is fixed.

4. The method for manufacturing a bent optical fiber according to claim 1, wherein the infrared laser pulsed light includes laser light with a wavelength over 1.5 μm.

5. The method for manufacturing a bent optical fiber according to claim 1, wherein the infrared laser pulsed light to irradiate the first irradiation region has a power distribution in which thermal power in the first bend processing portion is higher than thermal power in the rest portion except for the first bend processing portion.

6. The method for manufacturing a bent optical fiber according to claim 1, wherein the heated section of the optical fiber is bent in the predetermined radius of curvature by controlling a pulse count of the infrared laser pulsed light to irradiate one irradiation region and a center distance of each of the plurality of irradiation regions, as an irradiation condition with the infrared laser pulsed light to irradiate each of the plurality of irradiation regions.

7. The method for manufacturing a bent optical fiber according to claim 1, wherein the heated section of the optical fiber is bent in the predetermined radius of curvature by setting the number of the plurality of irradiation regions each irradiated with the infrared laser pulsed light.

8. The method for manufacturing a bent optical fiber according to claim 1, wherein the optical fiber is a multi-core optical fiber having a plurality of cores extending along a predetermined axis, and wherein the multi-core optical fiber is bent so that there is no neighboring core out of the plurality of cores on a bend axis which is defined by a straight line perpendicular to the predetermined axis and which coincides with a bend direction in each of the first bend processing portion and the second bend processing portion.

9. A method for manufacturing a bent optical fiber obtained by performing bend processing for an optical fiber comprised of silica glass and having a first end face and a second end face opposed to the first end face, the method comprising:
irradiating an irradiation region of the optical fiber with laser light having a thermal power distribution with a maximum thermal power on an optical axis of the optical fiber, and bending the optical fiber in a bend processing portion having a width narrower than a width of the irradiation region along a longitudinal direction of the optical fiber and softened by irradiation with the laser light, in an irradiation period with the laser light;
moving an irradiation position with the laser light along the longitudinal direction of the optical fiber, the moving being executed after the bending of the optical fiber, by a moving amount defined in such a manner that, in next laser irradiation to form a next irradiation region and a next bend processing portion included in the next irradiation region in the optical fiber, the irradiation region in the bending of the optical fiber overlaps in part with the next irradiation region and the bend processing portion in the bending of the optical fiber is separated from the next bend processing portion; and
repeating the bending of the optical fiber and the moving of the irradiation position in a heated section set between the first end face and the second end face of the optical fiber, thereby bending the optical fiber in a predetermined radius of curvature in the heated section of the optical fiber.

10. The method for manufacturing a bent optical fiber according to claim 9, wherein the laser light includes infrared laser pulsed light.
